(19) United States
(12) Patent Application Publication
(10) Pub. No.: US 2006/0245154 A1
(43) Pub. Date: Nov. 2, 2006

(54) Display device having a foldable base

(75) Inventor: Han-Kuang Ho, Zhonghe City (TW)

Correspondence Address: SNELL & WILMER, 400 EAST VAN BUREN, ONE ARIZONA CENTER, PHOENIX, AZ, 85004-2202, US

(73) Assignee: BENQ CORPORATION

(21) Appl. No.: 11/403,675

(22) Filed: Apr. 13, 2006

(30) Foreign Application Priority Data
Apr. 28, 2005 (TW) 94113676

(51) Int. Cl. G06F 1/16

(52) U.S. Cl. 361/682

(57) ABSTRACT

A display device having a foldable base is provided. The display device includes a monitor and a foldable base for supporting the monitor. The foldable base includes a first unit connected to the monitor, an adjustable element with a first end movably disposed in the first unit and a second end rotatable with respect to the first end, and a second unit rotatably connected to the second end. The second unit is selectively posed in a first position or a second position with respect to the first unit.

### CROSS-REFERENCE TO RELATED APPLICATIONS

This application claims the right of priority based on Taiwan Patent Application No. 094113676 entitled “A Display Device Having A Foldable Base,” filed on Apr. 28, 2005, which is incorporated herein by reference and assigned to the assignee herein.

### FIELD OF INVENTION

The present invention generally relates to a display device, and more particularly, to a display device with a foldable base.

### BACKGROUND OF THE INVENTION

Most conventional display devices are each provided with a base and a monitor. The base needs enough size and area to support the monitor of display device.

During shipping, the manufacturers generally apply either of following packing methods. The first one is to assemble the base and the monitor into a display device and then proceed to pack. The other one is to put the monitor and base into the packing carton separately to reduce volume, and users need to take the monitor and base out to assemble the display device by themselves. In the former method, the larger carton and more packing material for protecting the display device from impact during shipping increases the cost of packing and shipping. On the other hand, the latter method may cause missing-part mistakes due to human error. For example, the carton may be sealed without the base of display device inside. Such an incomplete display device will be returned, which is bothersome to users and damages the credit of manufacturers.

Therefore, the present invention provides a display device with a foldable base, which needs less packing materials and shipping volume such that the cost of packing and shipping is reduced.

### SUMMARY OF THE INVENTION

The present invention relates to a display device with a foldable base. Without separating the elements, the overall size of the display device may be reduced and less packing materials and shipping volume are needed reducing the cost of packing and shipping.

In accordance with one embodiment of the invention, a display device of the invention having a foldable base, includes a monitor and a foldable base supporting the monitor. The foldable base comprises a first unit connected to the monitor, an adjustable element with a first end movably disposed in the first unit and a second end rotatable with respect to the first end, and a second unit rotatably connected to the second end and being selectively located in a first position or a second position with respect to the first unit.

In accordance with another embodiment, the display device of the invention having a foldable base, includes a monitor and a foldable base supporting the monitor. The foldable base comprises a first unit connected to the monitor, a second unit movably connected to the first unit, and an adjustable element with a first end pivotally connected to the first unit and a second end movably disposed in the second unit. The second end is rotatable with respect to the first end to locate the second unit in a first position or a second position with respect to the first unit.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a schematic diagram of a display device of the present invention;

FIGS. 2a-2c are schematic diagrams of a first embodiment of the present invention, illustrating the second unit switching to the second position; and

FIGS. 3a-3c are schematic diagrams of a second embodiment of the present invention, illustrating the second unit switching to the second position.

### DETAILED DESCRIPTION

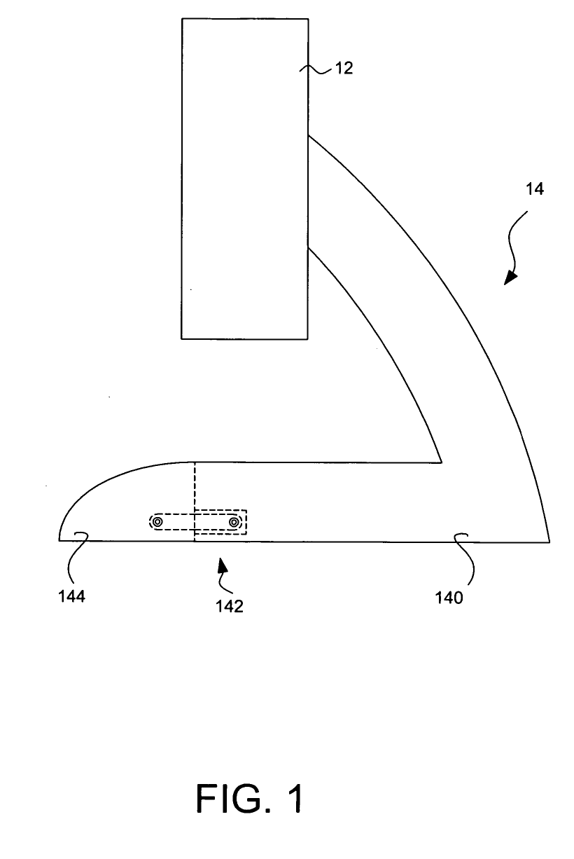

With reference to FIG. 1, the present invention provides a display device 10 with a foldable base 14. The size of the display device 10 may be reduced without disassembling.

Less packing materials and smaller shipping volume are therefore required, and thus the cost of packing and shipping the device can be reduced.

In following embodiments, the display device 10 comprises a monitor 12 and a foldable base 14 supporting the monitor 12. The monitor 12 may be flat panel display monitor or any other display monitor. The foldable base 14 comprises a first unit 140, an adjustable element 142, and a second unit 144. The first unit 140 connects and supports the monitor 12. The second unit 144 is rotatably connected to the first unit 140, and is located in a first position as adjacent to the first unit 140.

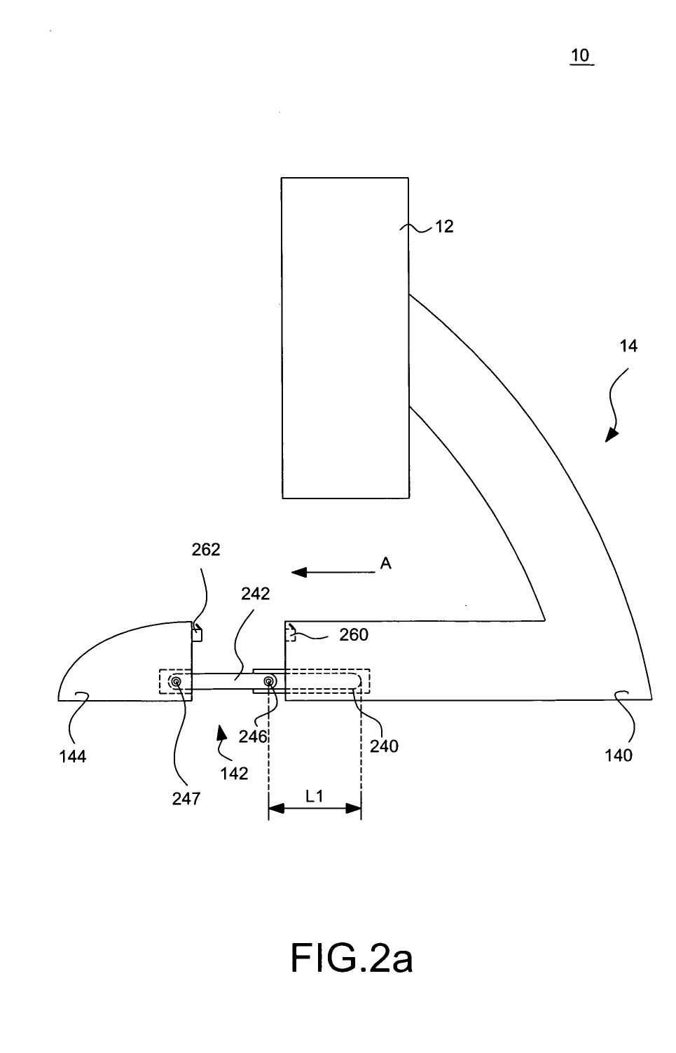

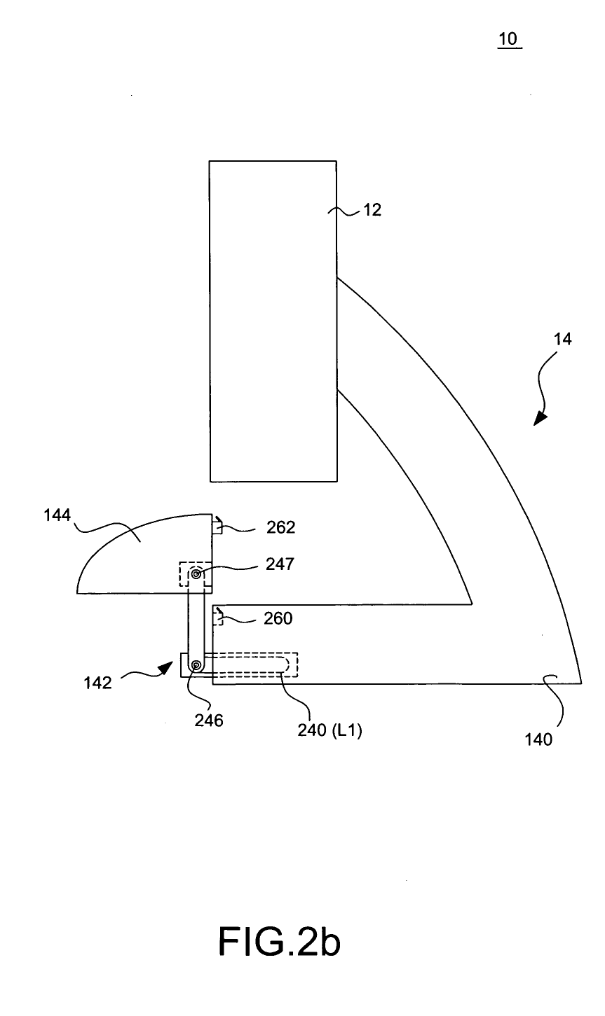

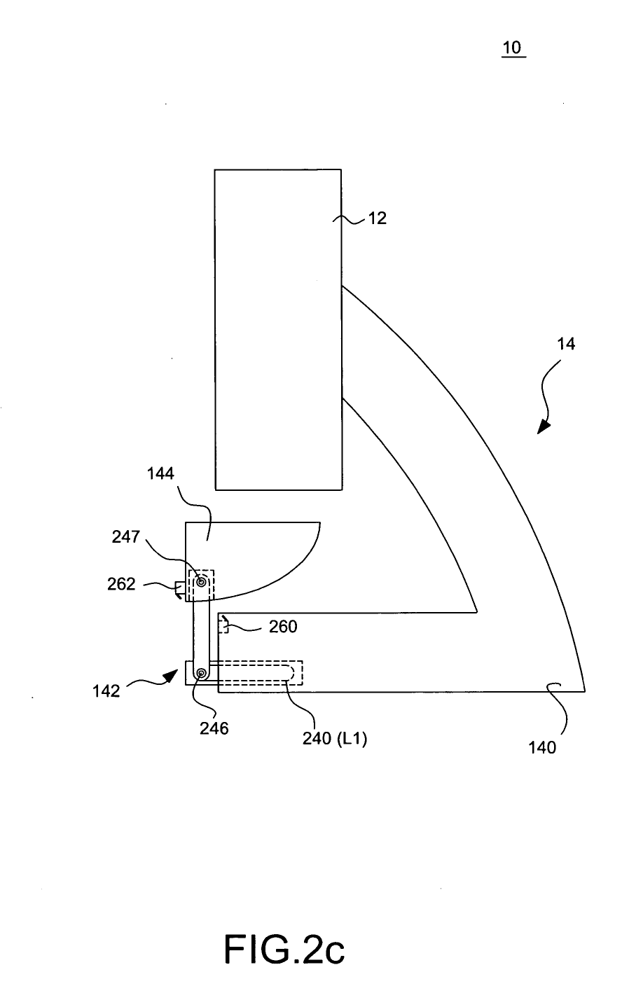

FIGS. 2a, 2b, and 2c are schematic diagrams of a first embodiment of the present invention, illustrating the second unit 144 switching from the first position (As shown in FIG. 1) to the second position (As shown in FIG. 2c). As shown in FIG. 2a, the adjustable element 142 has a first end 246 and a second end 247. In this embodiment, the first end 246 of the adjustable element 142 is movably disposed in the first unit 140, and the second end 247 of the adjustable element 142 is rotatable with respect to the first end 246. The second unit 144 is rotatably connected to the second end 247, and the second unit 144 is selectively located in a first position (As shown in FIG. 1) or a second position (As shown in FIG. 2c) with respect to the first unit 140.

In this embodiment, a first track 240 is provided in the first unit 140 and the first end 246 of the adjustable element 142 is movable along the first track 240. The first track 240 has a first length L1, and the second unit 144 is moved the first length L1 along a first direction A to depart from the first unit 140.

As shown in FIG. 2b, the second end 247 is rotated with respect to the first end 246 of the adjustable element 142 and the adjustable element 142 is perpendicular to a surface that the first unit 140 is placed on. The bottom portion of the second unit 144 is parallel to the surface that the first unit 140 is placed on, and the second unit 144 is located above the first unit 140.

After the second end 247 is rotated with respect to the first end 246 of the first unit 140, the second unit 144 is rotated with respect to the second end 247 to arrive at a second position. As shown in FIG. 2c, the second unit 144 is placed in the second position, and the foldable base 14 of display device 10 occupies a smaller space, since the second unit 144 is located above the first unit 140.

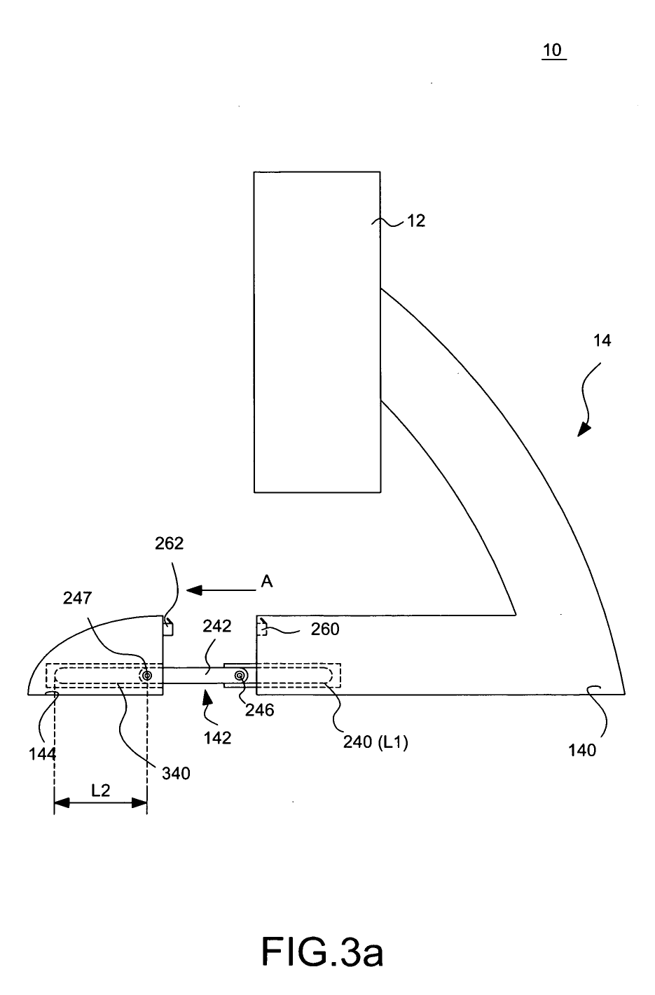

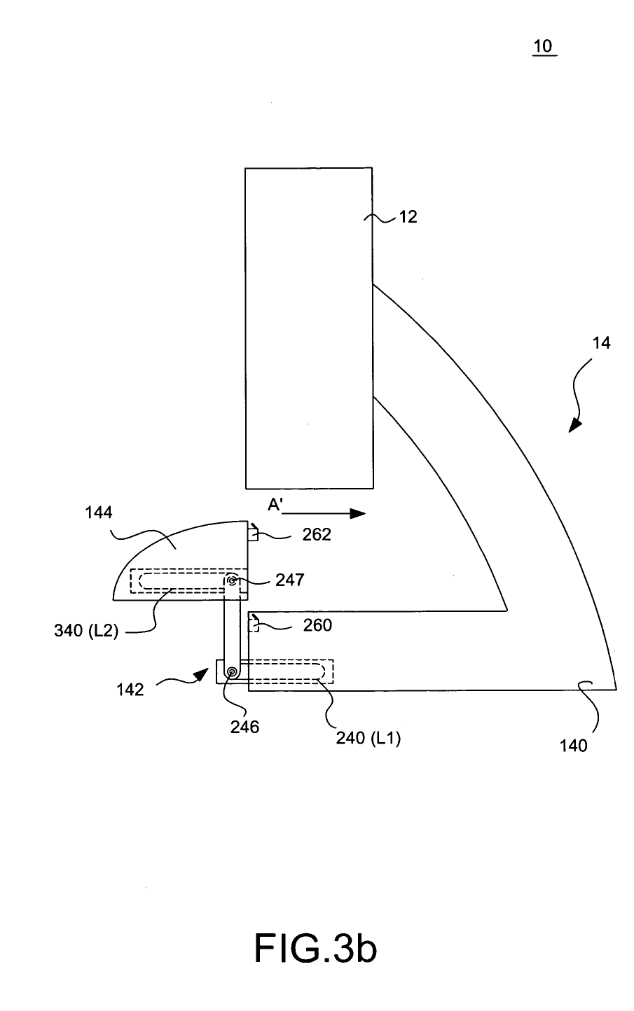

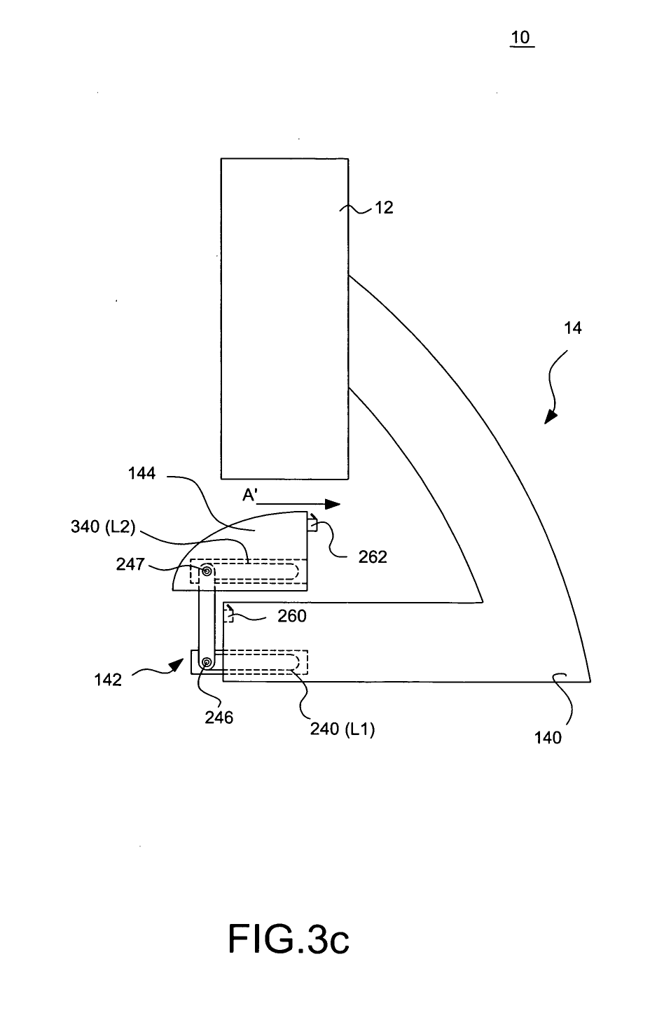

FIGS. 3a, 3b, and 3c are schematic diagrams of a second embodiment of the present invention illustrating the second unit 144 switching from the first position (As shown in FIG. 1) to the second position (As shown in FIG. 3c). As shown in FIG. 3a, the adjustable element 142 comprises a first end 246 pivotally connected to the first unit 140 and a second end 247 movably disposed in the second unit 144, and the second end 247 is rotatable with respect to the first end 246 to locate the second unit pose in a first position (As shown in FIG. 1) or a second position (As shown in FIG. 3c) with respect to the first unit 140.

As shown in 3a, a first track 240 is provided in the first unit 140 and the first end 246 of the adjustable element 142 is movable along the first track 240. Moreover, a second track 340 is provided in the second unit 144 and the second end 247 of the adjustable element 142 is movable along the second track 340. The second track 340 has a second length L2, and the second unit 144 is moved the second length L2 along a first direction A and is departed from the first unit 140. As known to those skilled in the art, despite of the descriptions in the second embodiment, the display device 10 may selectively have the second track 340 only.

As shown in FIG. 3b, the second end 247 is rotated with respect to the first end 246 of the adjustable element 142 and the adjustable element 142 is perpendicular to a surface that the first unit 140 is placed on. The bottom portion of the second unit 144 is parallel to the surface that the first unit 140 is placed on, and the second unit 144 is located above the first unit 140.

After the second end 247 is rotated with respect to the first end 246 of the first unit 140, the second unit 144 is moved the second length L2 along a second direction A′ to arrive at the second position. As shown in FIG. 3c, the second unit 144 is placed in the second position, and the foldable base 14 of display device 10 occupies a smaller space since the second unit 144 is located above the first unit 140.

As shown in FIGS. 2a-2c and FIGS. 3a-3c, the first unit 140 further comprises a first positioning part 260, and the second unit 144 comprises a second positioning part 262 corresponding to the first positioning part 260. As the second unit 144 is placed in the first position, the engagement of between the first positioning part 260 and the second positioning part 262 fastens the combination of the first unit 140 and the second unit 144. The first positioning part 260 is a female element (e.g., a hole) or a male element (e.g. a protrusion), and the second positioning element 262 is respectively a male element or a female element.

In each embodiment described above, the adjustable element 142 may be a linkage structure which comprises a rod 242 and two bolts 246, 247 disposed at two ends of the rod 242. However, any element which can provide similar adjustment function may be used as the adjustable element 142.

Although specific embodiments have been illustrated and described, it will be obvious to those skilled in the art that various modifications may be made without departing from the scope of the appended claims.

1. A display device having a foldable base, comprising:
a monitor; and
a foldable base supporting said monitor, comprising:
a first unit connected to said monitor;
an adjustable element with a first end movably disposed in said first unit and a second end rotatable with respect to said first end; and
a second unit rotatably connected to said second end and being selectively located in a first position or a second position with respect to said first unit.

2. The display device of claim 1, wherein, said second unit is adjacent to said first unit as said second unit is located in said first position, and said second unit is separated from and located above said first unit as said second unit is placed in said second position.

3. The display device of claim 2, further comprising a first track with a first length provided in said first unit, wherein said first end is movable along said first track.

4. The display device of claim 3, wherein, said second unit is moved said first length along a first direction, rotated with respect to said first end, and rotated with respect to said second end to be placed in said second position.

5. The display device of claim 1, further comprising:
a first positioning part disposed on said first unit; and
a second positioning part corresponding to said first positioning part disposed on said second unit;
wherein as said first positioning part and said second positioning part are connected together, said second unit is located in said first position and connected to said first unit.

6. The display device of claim 5, wherein said first positioning part is a female element and said second positioning element is a male element.

7. The display device of claim 5, wherein said first positioning part is a male element and said second positioning element is a female element.

8. The display device of claim 1, wherein said adjustable element comprises a linkage structure.

9. The display device of claim 8, wherein said linkage structure comprises a rod and two bolts disposed at two ends of said rod.

10. A display device having a foldable base, comprising:
a monitor; and
a foldable base supporting said monitor, comprising:
a first unit connected to said monitor;
a second unit movably connected to said first unit; and
an adjustable element with a first end pivotally connected to said first unit and a second end movably disposed in said second unit, said second end being rotatable with respect to said first end to locate said second unit in a first position or a second position with respect to said first unit.

11. The display device of claim 10, wherein, said second unit is adjacent to said first unit as said second unit is located in said first position, and said second unit is separated from and located above said first unit as said second unit is placed in said second position.

12. The display device of claim 11, further comprising a second track with a second length provided in said second unit, wherein said second end is movable along said second track.

13. The display device of claim 12, wherein, said second unit is moved said second length along a first direction, rotated with respect to said first end, and moved said second length along a second direction to be placed in said second position.

14. The display device of claim 13, wherein said second direction is opposite to said first direction.

15. The display device of claim 10, wherein said adjustable element comprises a linkage structure.

16. The display device of claim 15, wherein said linkage structure comprises a rod and two bolts disposed at two ends of said rod.

17. The display device of claim 10, further comprising:
a first positioning part disposed on said first unit; and
a second positioning part corresponding to said first positioning part disposed on said second unit;
wherein as said first positioning part and said second positioning part are connected together, said second unit is located in said first position and connected to said first unit.

18. The display device of claim 17, wherein said first positioning part is a female element and said second positioning element is a male element.

19. The display device of claim 17, wherein said first positioning part is a male element and said second positioning element is a female element.
